(19) United States
(12) Patent Application Publication
(10) Pub. No.: US 2024/0062510 A1
(43) Pub. Date: Feb. 22, 2024

(54) APPARATUS AND METHOD FOR DETERMINING THE LIGHTING CHARACTERISTICS OF A LIGHTING FIXTURE

(71) Applicant: PSLab Holding Ltd, London (GB)

(72) Inventor: Dimitri SADDI, London (GB)

(73) Assignee: PSLab Holding Ltd, London (GB)

(21) Appl. No.: 18/235,237

(22) Filed: Aug. 17, 2023

(30) Foreign Application Priority Data
Aug. 19, 2022 (DE) 102022120995.4

(51) Int. Cl. G06V 10/60; G06T 7/90; H05B 47/105

(52) U.S. Cl. CPC G06V 10/60; G06T 7/90; H05B 47/105

(57) ABSTRACT

The present disclosure relates to an apparatus for determining the lighting characteristics of a lighting fixture having a camera for capturing a wall image produced on a wall by the lighting fixture and for providing a camera image based on the captured wall image, and having an image evaluation device for evaluating the camera image. The image evaluation device has a rectification module for rectifying the camera image, an illuminance and/or color and/or spectral distribution module for determining an illuminance and/or color and/or spectral distribution in the rectified camera image, and a luminous intensity and/or color point and/or radiant intensity distribution module for determining the luminous intensity distribution and/or angle-dependent color point distribution and/or spectral radiant intensity distribution of the lighting fixture based on the previously determined illuminance and/or color and/or spectral distribution.

### CROSS-REFERENCE TO RELATED APPLICATIONS

This application claims priority to German Patent Application No. DE 102022120995.4 filed Aug. 19, 2022, the disclosure of which is hereby incorporated in its entirety by reference herein.

### TECHNICAL FIELD

The present disclosure relates to an apparatus and a method for determining the lighting characteristics of a lighting fixture, wherein a camera captures a wall image produced on a wall by the lighting fixture and a camera image based on the captured wall image is provided to an image evaluation device that evaluates the camera image in order to determine the lighting characteristics of the lighting fixture. The disclosure also relates to an apparatus and a method for visualizing the lighting characteristics of the lighting fixture that have been determined in this way.

### BACKGROUND

In today's world, high-quality lighting tasks require lighting fixtures with precisely defined lighting characteristics in order to provide the desired illumination of a specific object, a building space, or the target area in general. Users such as architects, lighting fixture developers, and lighting designers require not only specific color temperatures, luminous intensities, or luminous fluxes, but also precise information about the illuminances on the illuminated object or target area, the luminous intensity distribution and/or angle-dependent color point distribution and/or spectral radiant intensity distribution of the lighting fixture, the isolux curve, biological effects of light on the human organism, and the like, and require precise evidence of these. In this connection, not only should the lighting characteristics be provided in abstract form by the lighting fixture manufacturer, but also it should be possible to measure them on site in various installation environments; users such as architects, lighting designers or developers, and manufacturers also want a visualization in the particular installation environment of the lighting fixture and optionally also nominal/actual comparisons of the lighting characteristics as well as inline checks.

Up to now, the lighting characteristics of a lighting fixture have often been determined by the lighting fixture manufacturer using measurement and calculation, for example with the aid of light density measuring cameras relative to which the lighting fixture is tilted or the light cone is tilted by means of a mirror in order to scan the light density. Similarly, indirect measurements of luminous intensity distributions are also known, for example by means of goniophotometers, in which high-quality imaging systems, for example comprising Fresnel lenses, are used to cast the light cone onto a measuring wall on which the light density is then scanned.

Based on this, to the disclosure aims at creating improved apparatuses and methods of the type mentioned above, which avoid the disadvantages of the prior art and to further develop the latter in an advantageous manner. In particular, the aim is to enable a simple and precise determination of lighting characteristics of a lighting fixture in different installation environments with variable mounting positions of the lighting fixture and measuring device.

It is therefore proposed to determine the lighting characteristics of the lighting fixture indirectly by means of a camera image, which is captured from a target area of the lighting fixture on a preferably flat, but possibly also curved wall illuminated by the lighting fixture and is then evaluated. The evaluation procedure here makes it possible to vary the mounting position of the lighting fixture relative to the wall and compensates for this or takes it into account the evaluation.

According to the disclosure, a rectification module calculates a rectified camera image based on the camera image provided by the camera, which replicates the wall image produced on the wall by the lighting fixture. Based on the rectified camera image, an illuminance and/or color and/or spectral distribution module then calculates relative illuminances and/or color values and/or spectral distributions in different pixels and/or image areas of the rectified camera image, and provides an illuminance and/or color and/or spectral distribution based thereon or corresponding thereto. Finally, a luminous intensity and/or color point and/or radiant intensity distribution module uses the illuminance and/or color and/or spectral distribution previously determined in the rectified camera image to determine the luminous intensity distribution or luminous intensity distribution curve LDC and/or the angle-dependent RGB color point distribution and/or the spectral radiant intensity distribution of the lighting fixture and/or its far-field distribution and/or angular distribution with respect to luminous intensity, color point, and/or spectral radiant intensity.

Distortion effects that may be due to the camera lens or may also be caused by a curvature of the wall can be corrected through the rectification of the camera image, basically making it possible to mount the lighting fixture in various positions to suit the particular installation environment and still obtain a correct determination of the lighting characteristics. Such distortion effects are well-known, for example, in so-called fish-eye lenses, which bend vertical and horizontal lines in a more or less arc-shaped manner.

In order to correct such distortion effects, the rectification module can have an identification device for identifying key contours in the camera image, which can be straight contours and/or right angles in the wall image that is captured by the camera. With the aid of a calculation module, the curvature deviation and/or angular deviation between the key contour that is identified in the camera image and the in particular straight or right-angled key contour that is actually present in the wall image can be determined in order, based on the determined curvature deviation and/or angular deviation, to then provide a rectified camera image that is a manipulated camera image or virtual image, so to speak, which is in fact based on the camera image shot by the camera, but in which the contours that have been curved and/or angularly distorted in the process have been straightened out again.

For example, a marking with a predetermined contour such as one or more horizontal lines and/or one or more vertical lines can be specified on the wall as the key contour. This can be done, for example, by means of a marking that is actually applied onto the wall, or can also projected onto the wall by imaging optics or also by means of a laser, for example in the form of a grid pattern or a checkerboard pattern; it can be advantageous to position the imaging apparatus, for example comprising a projector, in the vicinity or immediate vicinity of the lighting fixture and/or camera in order to achieve similar optical conditions. In the camera image captured by the camera, the above-mentioned markings in the wall image are detected and identified, for example, by means of a contour recognition device, whereupon the contour in the camera image can be compared to the known contour of the marking on the wall in order to then manipulate and thereby rectify the camera image based on the calculated contour deviations and/or angular deviations.

The rectified camera image is then evaluated with regard to the illuminances and/or color values and/or spectral distribution occurring in the rectified image; in this case, it is possible to first determine relative lux numbers and/or relative color point differences and/or relative spectral differences. More precisely, it is possible to determine the areas in which more or less lux occur than in other areas and by how many they differ and/or the areas in which higher or lower color temperatures occur than in other areas and by how much they differ and/or the ways in which color points deviate from those in other areas and/or the locations in which spectral deviations occur and what kind of deviations they are; in this case, initially no determinations are made yet with regard to absolute lux numbers and/or absolute color values and/or absolute color point coordinates or absolute spectral distributions.

If not only illuminances but also colors are detected and analyzed in order to determine the angle-dependent color point distribution of the lighting fixture, then it should be noted that for a precise definition or unambiguous identification of a color, the “color point” is usually specified or identified; this color point refers in an intrinsically known way to a color diagram and indicates the XY coordinates in such a color diagram. The “color temperature” is in fact included in such a color diagram, but it designates only a rather small range therein. The term “color temperature” in this context refers to the color of a perfect black body that has the specified temperature and correspondingly emits light of a corresponding color. In order to be able to specify the respective color more precisely, it has become common practice to identify the color point in a color diagram.

If the spectral distribution is also determined for various locations or areas on the wall or in the camera image and if the spectral radiant intensity distribution of the lighting fixture is determined based on this, then it should be noted that the color distribution and the illuminance distribution can also intrinsically be calculated from the spectral distribution, since the spectral distribution contains this information or more precisely, this information can be calculated from it. Depending on which sensor system is used, it is therefore possible to determine the illuminances and/or the color points based on the detected spectral distribution or even to detect them directly by sensor in another way.

In principle, other information can also be obtained from the above-mentioned spectral distribution, for example the biological effects of the correspondingly characterized light on humans in the sense of, for example, melatonin or serotonin release effects so that a lighting fixture can also be characterized by the spectral radiant intensity distribution in terms of its biological effects.

Depending on the area size to be captured, it is possible to use different sensor types. For example, the color distribution on the wall can be determined by an RGB sensor of a camera. If the spectral distribution is to be determined, then a hyperspectral camera can be used. If on the other hand, the illuminance is to be determined by itself or in addition, then an illuminance sensor can be used.

In particular, the above-mentioned illuminance and/or color and/or spectral distribution module can include a comparator for comparing illuminances and/or color temperatures or color points in different pixels and/or image areas of the rectified camera image relative to each other in order to determine a relative illuminance and/or color distribution in the rectified camera image. Alternatively or additionally, the above-mentioned comparator can also be embodied to compare spectral distributions in different pixels and/or image areas of the rectified camera image relative to each other and to determine relative spectral distribution deviations.

In order to arrive at absolute illuminances and an absolute color point distribution and/or spectral distribution, the illuminance and/or color and/or spectral distribution module can, in addition to the above-mentioned comparator, comprise a calibration device, which uses the previously determined relative lux numbers and/or relative illuminances and/or color values or color points provided by the comparator to determine the illuminance and/or color distribution with absolute illuminance values and/or color points. In a corresponding way, the calibration device can use the relative spectral distribution deviations to calculate or determine absolute spectral distributions in the pixels or image areas.

In this context, the calibration device can basically be embodied in different ways and operate in different ways. In a further development of the disclosure, the calibration device can, for example, comprise one or more illuminance and/or color value sensors, for example in the form of a spectrometer for measuring the actual illuminance and/or the actual spectrum, particularly in the sense of the above-mentioned color point, in one or more pixels and/or image areas, in which case the above-mentioned illuminance and/or color value sensor can, for example, be mounted directly on the wall or be aimed at the wall on which the wall image is produced. Alternatively or in addition to a color value or RGB sensor, it is also possible to use a hyperspectral camera that can detect the spectrum pixel-by-pixel by means of a sensor matrix.

If the actual illuminance or an actual color value in one or more pixels or image areas is known from sensor detection, then a calibration factor or an illuminance and/or color value correction factor or a spectral distribution correction function can be determined, which can then be used to convert the relative illuminances or color values into actual, absolute illuminances or absolute color values such as color temperatures or color points and/or to convert the spectral distribution deviations into actual spectral distributions.

Alternatively or in addition to such a sensor calibration by means of an illuminance or color value sensor or a hyperspectral camera, it is also possible to perform a computational determination of absolute illuminance and/or color values based on relative illuminance and/or color values, particularly with the aid of known or previously determined characteristics of the illuminated wall, in particular its reflectance and its Lambertian emission characteristics. In particular, the reflectance and/or the re-emission behavior and/or the Lambertian emission characteristics of the wall and the light density and/or the light spectrum determined in a point and/or in an area section can be used as a basis for a calibration and the absolute luminous intensity distribution and/or the angle-dependent color point distribution and/or the spectral radiant intensity distribution of the lighting fixture can be determined based on the camera image.

Alternatively or additionally, the calibration device can also have an imaging illumination device for illuminating the wall with a predetermined light-and-dark and/or color value pattern, in particular a predetermined black/white pattern such as a checkerboard, in which case the comparator of the illuminance and/or color and/or spectral distribution module can be embodied, as part of a calibration procedure, to determine the relative illuminance values for light and dark pixels and/or image areas of the above-mentioned predetermined light-and-dark pattern or relative color temperature values for the color value pattern. Based on the knowledge of the black and white fields in the wall image of the calibration run, for example, it is then possible in turn to determine a calibration factor or illuminance and/or color value conversion factor that the illuminance and/or color and/or spectral distribution module can then use to determine absolute illuminance and/or color values based on the relative illuminance values in the rectified camera image.

In this case, the above-mentioned calibration device can alternatively or additionally also be used to calibrate the imaging illumination device. For example, if the rectification effect of the camera has already been determined by the rectification module, for example by applying actually straight grid lines or grid lines of a known path on the wall, or if the camera has already been calibrated, then a predetermined light-and-dark pattern, for example in the form of a grid line pattern, can be projected onto the wall, for example by the imaging illumination device. Based on the camera image of the already calibrated camera, the calibration device can then determine the extent to which the grid line pattern or light-and-dark pattern of the imaging illumination device that is actually projected onto the wall is distorted, based on which the calibration device can then determine the rectification of the imaging illumination device.

Alternatively or additionally, however, it is also possible for the calibration device to calibrate both the camera and the imaging illumination device. For this purpose, a reference pattern projected onto the wall by the imaging illumination device can be captured, for example with a stereo camera or with two cameras spaced apart from each other with preferably parallel but possibly also crossed “viewing axes”. Based on the known or to-be-determined coordinates of the camera position and the position of the imaging illumination device, the calibration device can then calibrate both units, i.e. the camera and the imaging illumination device, with the aid of a predetermined mathematical model by matching the two images taken by the stereo camera or the spaced-apart cameras to each other.

If the illuminance and/or color and/or spectral distribution has been determined for the rectified camera image, then based on this, the luminous intensity and/or color point and/or radiant intensity distribution module can determine the luminous intensity and/or angle-dependent color point and/or spectral radiant intensity distribution of the lighting fixture, in which case the above-mentioned luminous intensity and/or color point and/or radiant intensity distribution module can in particular be embodied to take into account the position of the lighting fixture relative to the wall and/or the geometry of the wall surface section illuminated by the lighting fixture and its geometric relationship to the lighting fixture.

The position and/or geometric relationship of the lighting fixture relative to the wall or wall image can, for example, be manually entered via a suitable input interface of the apparatus and/or be detected by an automatic position determination device and provided to the luminous intensity and/or color point and/or radiant intensity distribution module via the above-mentioned input interface, for example in the form of a coordinate data set indicating the position of the lighting fixture relative to the wall section that the camera captures as a camera image.

The above-mentioned position data can in particular include the distance of the lighting fixture from the wall and/or a transverse offset of the lighting fixture relative to the center or middle of the wall image being captured or of a predetermined wall image point such as two opposite corners.

The above-mentioned transverse offset can be determined in various ways, for example the radial distance from a perpendicular to the wall image center and/or the horizontal and vertical offset from it when the wall is perpendicular, or can mean the north-south and/or east-west offset when the wall image is projected onto a ceiling or the floor. For example, the position data set can include the distance of the lighting fixture perpendicular to the wall and the vertical and horizontal offset of the lighting fixture relative to the center of the wall image produced by the lighting fixture and captured by the camera.

In this case, the above-mentioned position data can be detected by sensors such as distance sensors and/or position sensors.

In order to be able to variably adapt the capture of the camera image to the particular installation environment and component design, a predetermined evaluation area on the wall can be specified for the camera image that is to be evaluated. Such an evaluation area for the camera image that is to be evaluated can be variably defined, particularly in the form of a rectangle, which can be defined, for example, by the illuminated wall or can be a predetermined subsection of the wall onto which the light cone of the lighting fixture is cast.

Advantageously, the above-mentioned area selection module can variably preset the evaluation area, preferably with regard to the area or size and/or with regard to the format, for example in the form of a portrait rectangle, a landscape rectangle, or a square. For example, if a museum spotlight or surgical light is to be measured or determined with regard to its lighting characteristics, the above-mentioned area selection module can adapt the evaluation area, for example, to the format of a painting that is to be illuminated or to the surgical light's target area that is to be illuminated.

Alternatively or additionally, the camera can also capture several images in different evaluation areas of the wall image, which an image processing device can then assemble to form an overall camera image that replicates the desired amount the wall image. The wall image of the lighting fixture can be moved into a fixed evaluation area of the camera by moving, e.g. rotating, the lighting fixture relative to the wall. Alternatively or additionally, the camera can be moved, e.g. tilted, relative to the wall in order to capture different evaluation areas of the wall image in different images. In this way, it is possible to completely capture even lighting fixtures that actually illuminate “too large” an area on the wall.

There are various ways that the apparatus can output the specific lighting characteristics of the lighting fixture and bring it to the attention of the system user, for example by showing an information display that reflects the lighting characteristics.

In particular, in a further development of the disclosure, a visualization of the determined lighting characteristics of the lighting fixture can be shown in the wall image on the wall that is illuminated by the lighting fixture during the measurement or determination procedure. In particular, an imaging illumination device can be provided, which, as a function of the previously determined lighting characteristics, shows information in the wall image and/or next to the wall image on the wall that is illuminated by the lighting fixture.

For example, the imaging illumination device can show isoluxes and/or show a light distribution curve LDC and/or mark illuminance ranges and/or show spectral information in the wall image of the lighting fixture. It is possible for spectral information such as color temperatures or color points in certain pixels to be shown or for a sectional view with area depictions of certain color temperatures to be provided and/or for additionally shown explanations of the color temperatures to be provided. Distribution curves of the spectral distribution can also be displayed.

Showing the lighting characteristics or information reflecting the specific lighting characteristics directly in the wall image produced by the lighting fixture or in its immediate vicinity makes it particularly easy for a user of the system to classify and perceive the calculated or determined lighting characteristics and to compare them as needed.

Advantageously, a reference imaging device can also provide wall images and/or information about lighting characteristics of reference lighting fixtures, which can, for example, be shown in or next to the wall image of the lighting fixture that is being analyzed in order to be able to compare the lighting fixture that is being analyzed to the characteristics of a reference lighting fixture.

Advantageously, the reference imaging device can also provide the reference wall image or the reference information without the physical presence of the reference lighting fixture, for example by projecting it onto the wall via the above-mentioned imaging illumination device, specifically by using lighting characteristics that can be provided via an interface of the reference imaging device. For example, the reference imaging device can download the lighting characteristics such as the luminous intensity distribution curve or spectral distribution of a reference lighting fixture from the Internet or can acquire them through manual input to an input device, in order to then produce a corresponding reference image from the loaded or input lighting characteristics of the reference lighting fixture, which reference image can be projected onto the wall or can also be shown on a display device.

Advantageously, the above-mentioned reference image device in this case is embodied to take into account the distortion that the camera and/or the imaging illumination device exhibit and that is influenced by the installation location, i.e. the coordinates of the camera relative to the wall image and/or the coordinates of the imaging illumination device relative to the wall image. By taking the distortion effects of the camera and/or imaging illumination device into account, the reference image and/or the reference information about the reference lighting fixture can be provided so that they have an exact fit, so to speak, and can be actually comparable to the image and/or the information about the lighting fixture that is being analyzed, without the occurrence of different distortion effects.

In particular, the reference imaging device can comprise a control module which, based on the lighting characteristics of the reference lighting fixture such as luminous intensity distribution or spectral distribution, controls the imaging illumination device and/or a display device and in so doing, takes into account the distortion effects of the camera and/or imaging illumination device.

The above-mentioned imaging illumination device can, for example, be a projector that projects the lighting information onto the wall.

Alternatively or additionally, however, a display device with a screen can be provided on which, on the one hand, the camera image and/or the rectified camera image is shown and, on the other hand, additional information is displayed that reflects the previously determined lighting characteristics or was determined as a function thereof. In particular, the above-mentioned display device can comprise an overlay module that shows the information, which has been determined as a function of the previously determined lighting characteristics, in the camera image and/or in the rectified camera image that is displayed on the screen. Similar to the above-mentioned display in the wall image, this can be lighting information such as isoluxes, light distribution curves (LDC), RGB s, illuminance ranges, and the markings or spectral information thereof.

### BRIEF DESCRIPTION OF THE DRAWINGS

FIG. 1: depicts an apparatus for determining and visualizing the lighting characteristics of a lighting fixture according to an advantageous embodiment of the disclosure and shows the components of the apparatus and their interconnection with each other;

FIG. 2: is a perspective view of the positioning of the apparatus in front of a wall on which the lighting fixture produces a wall image;

FIG. 3: is a perspective view of the positioning of the lighting fixture that is to be measured relative to the wall, with partial view (a) showing a fixed mounted lighting fixture and partial view (b) showing a manually held lighting fixture during a measurement procedure;

FIG. 4: is a perspective view of the apparatus and of the wall image produced on the wall by the lighting fixture, with the various partial views (a) to (f) showing the visualization of various lighting characteristics by showing them in or on the wall image; and

FIG. 5: is a perspective view of the visualization of different lighting scenarios according to partial views (a) and (b) as a wall image and the projection of a checkerboard or light-and-dark pattern on the wall according to partial view (c) for calibrating the rectification of the camera image and calibrating the illuminance measurement.

### DETAILED DESCRIPTION

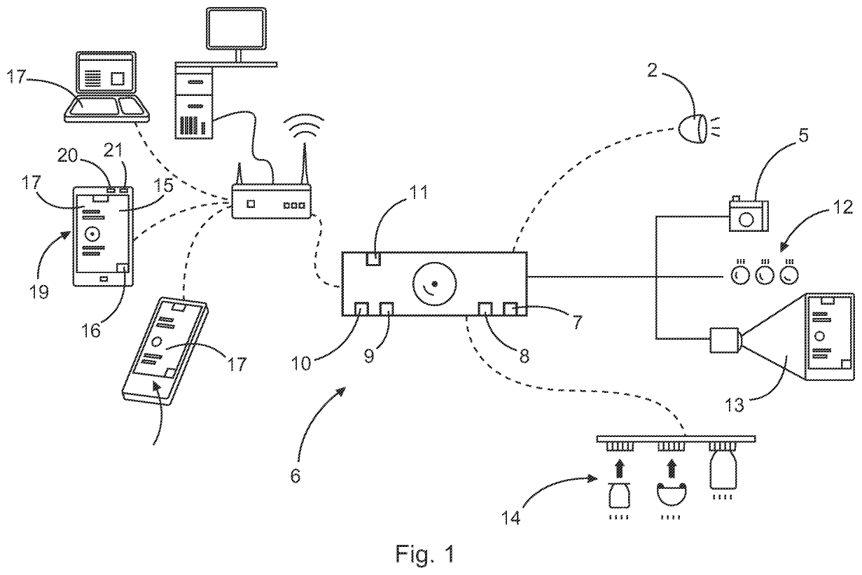

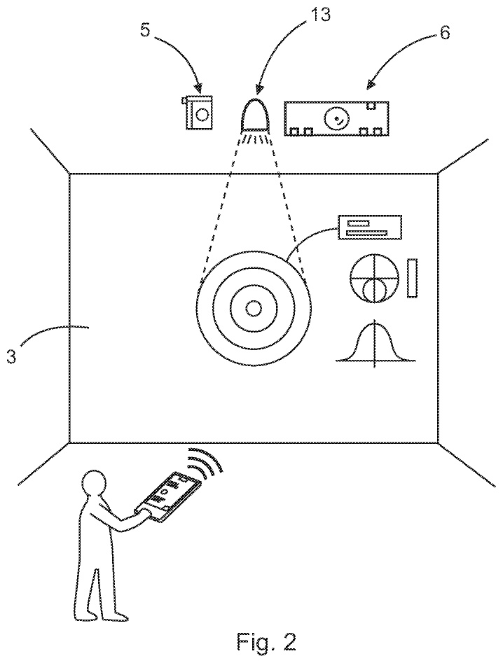

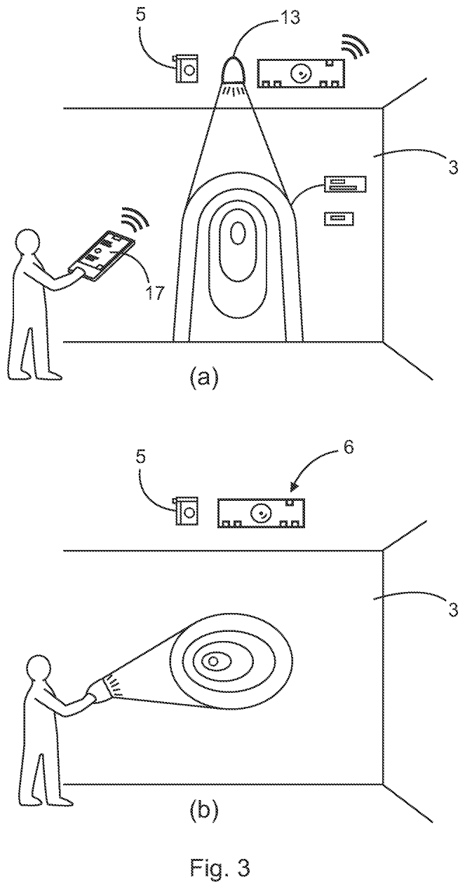

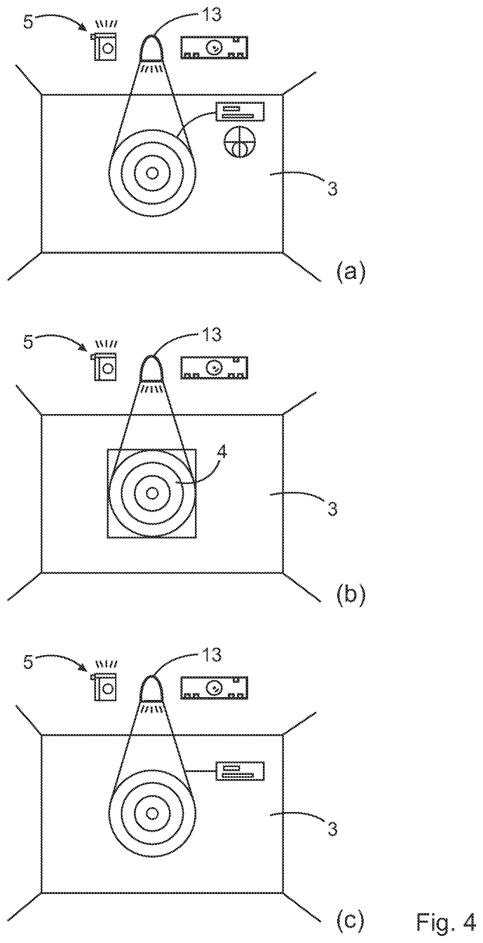

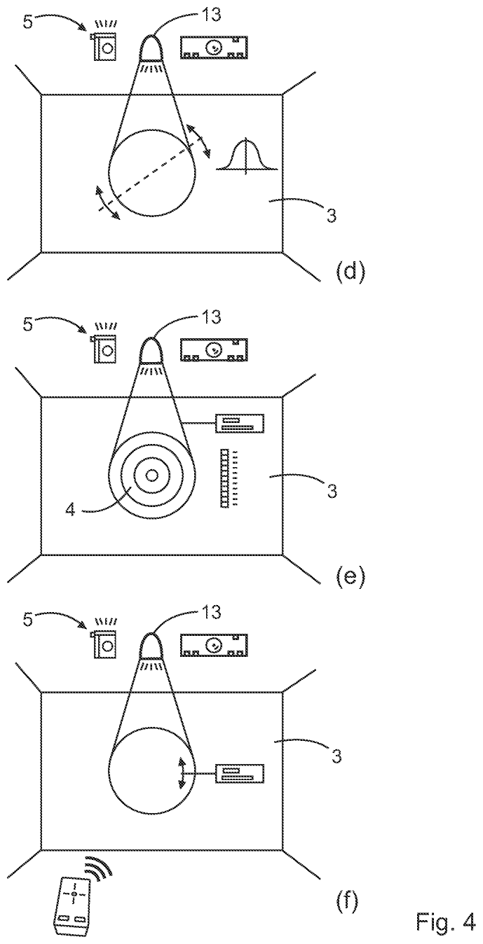

As FIGS. 1-3 show, one or more lighting fixtures 2 for producing one or more wall images 4 can be mounted on a wall 3 at a mounting position adapted to the installation environment, for example on a ceiling, but the lighting fixture 2 can also be positioned by hand in front of the wall to illuminate the above-mentioned wall image 4, see FIG. 3 partial view (b).

The above-mentioned wall 3 can, for example, be a wall of a building or room, but can also comprise a projection surface such as, for example, a projection screen or cinema screen, in which case the lighting fixture 2 can be mounted in an intended position range relative to the wall 3, which can also be the case when the lighting fixture 2 is in the operating state. For example, the lighting fixture 2 can be mounted within a range of 0.5 to 5 m or, for example, 2 to 3 m from the wall 3.

The wall image 4 produced on the wall 3 by the lighting fixture 2 is captured by means of a camera 5, which can, for example, be a digital camera that can provide a camera image in the form of a multitude of pixels. The camera 5 can advantageously be positioned in the vicinity of the lighting fixture 2, for example likewise mounted on the ceiling on which the lighting fixture 2 is also mounted, but other mounting variants such as a tripod or other holding devices can also be provided.

The camera 5 is aimed so that it captures the wall image 4 that is illuminated on the wall 3 by the lighting fixture 2.

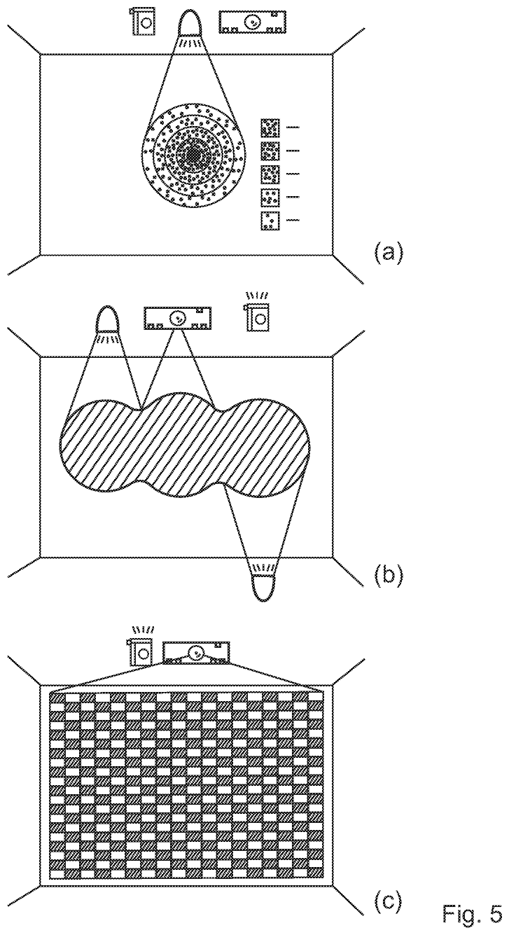

First, an evaluation area 18 is defined for the camera image that is to be evaluated, particularly in the form of a rectangle, which can be defined by the illuminated wall, for example, or can also be a subregion thereof, see FIG. 5b. This evaluation area 18 is defined independently of the specific light image on the wall and can be variably preset by the user by means of an area selection module 14, preferably defining a more or less wall-sized rectangular frame. The camera image, which can preferably replicate the entire evaluation area, is then evaluated in this predetermined evaluation area 18.

In general, the above-mentioned area selection module 14 can variably preset the evaluation area 18, preferably with respect to the area or size and/or with respect to the format, for example in the form of a portrait rectangle, a landscape rectangle, or a square. For example, if a museum spotlight or surgical light is to be measured or determined with regard to its lighting characteristics, then the above-mentioned area selection module 14 can adapt the evaluation area 18, for example, to the format of a painting that is to be illuminated or the surgical light's target area that is to be illuminated.

The camera image of the camera 5 is provided to an image evaluation device 6, which manipulates and evaluates the camera image in different steps, in particular rectifies and evaluates it.

The image evaluation device 6 can be composed of a computer or a server, in particular embodied at least partially in the form of one or more software modules that can be processed in a data processing device comprising a microprocessor and a program memory, for example in the form of the server shown in the drawings.

The above-mentioned image evaluation device 6 in the form of the server or another suitable computer device is further supplied with data or signals from one or more sensors 12, which can in particular comprise one or more illuminance and/or color value sensors that can comprise actual illuminance and/or color values in pixels and/or image areas of the wall image 4 in order to be able to carry out a calibration.

Alternatively or additionally, the above-mentioned sensors 12 can also comprise one or more position sensors, for example distance and/or position sensors, which can be used to determine the position of the lighting fixture 2 relative to the wall 3 by means of sensors. In particular, the above-mentioned sensors can determine the distance of the lighting fixture 2 from the wall 3 and its transverse offset in the sense of a horizontal and/or vertical offset with respect to a center of the wall image 4.

An input device 17, which can include, for example, a tablet connected to the server and/or can include control buttons or control elements on a control device, can be used to make various setup settings.

In particular, the above-mentioned input device 17 can first define an evaluation area 18 in the target area of the light cone of the lighting fixture 2, in particular on the wall 3, in which the image evaluation device 6 evaluates the camera image of the camera 5. The above-mentioned evaluation area 18 can be variably defined, preferably within reasonable limits, which on the one hand are adapted to the area illuminated by the lighting fixture 2 or to the wall image 4 and on the other hand can be completely captured by the camera 5.

For example, the evaluation area 18 can be carried out by tapping corner points on the tablet shown, on which a camera image of the wall 3 can be displayed.

If the evaluation area 18 has been defined, then the image evaluation device 6 can evaluate the image provided by the camera 5 in order to determine the lighting characteristics that are of interest.

In this case, a rectification module 7 can first calculate a rectified camera image based on the camera image provided by the camera 5, which replicates the wall image that the lighting fixture 2 produces on the wall 3.

Distortion effects that may be due to the camera lens or may also be caused by a curvature of the wall can be corrected through the rectification of the camera image 3, basically making it possible to mount the lighting fixture 2 in various positions to suit the particular installation environment and still obtain a correct determination of the lighting characteristics.

In order to correct such distortion effects, the rectification module 7 can have an identification device for identifying key contours in the camera image, which can be straight contours and/or right angles in the wall image 4 that is taken by the camera 5. The curvature deviation and/or angular deviation between the key contour that is identified in the camera image and the in particular straight or right-angled key contour that is actually present in the wall image, can be determined with the aid of a calculation module in order, based on the determined curvature deviation and/or angular deviation, to then provide a rectified camera image that is a manipulated camera image or virtual image, so to speak, which is in fact based on the camera image shot by the camera, but in which the contours that have been curved and/or angularly distorted in the process have been straightened out again.

For example, a marking with a predetermined contour such as one or more horizontal lines and/or one or more vertical lines can be specified as the key contour on the wall 3. This can be done, for example, by means of a marking that is actually applied onto the wall or can also be projected onto the wall 3 by imaging optics 13, for example in the form of a grid pattern or a checkerboard pattern, see FIG. 5 (c).

In this context, the imaging apparatus 13 can, for example, have a projector in the vicinity or immediate vicinity of the lighting fixture 2 and/or camera 5. In the camera image captured by the camera 5, the above-mentioned markings in the wall image are detected and identified, for example, by means of a contour recognition device, whereupon the contour in the camera image can be compared to the known contour of the marking on the wall 3 in order to then manipulate and thereby rectify the camera image based on the calculated contour deviations and/or angular deviations.

The rectified camera image is then evaluated with regard to the illuminances occurring in the rectified image; in this case it is possible to initially determine relative lux numbers. More precisely, it is possible to determine the areas in which more or less lux occur than in other areas; in this case, initially no determination is made yet with regard to absolute lux numbers.

In particular, an illuminance and/or color and/or spectral distribution module 8 can include a comparator 10 for comparing illuminances and/or color points and/or light spectra in different pixels and/or image areas of the rectified camera image relative to each other in order to determine a relative illuminance and/or color and/or spectral distribution in the rectified camera image.

In order to arrive at absolute illuminances and at an absolute illuminance distribution and/or color distribution and/or spectral distribution, the illuminance and/or color and/or spectral distribution module 8 can, in addition to the above-mentioned comparator 10, comprise a calibration device 11, which uses the previously determined relative lux numbers and/or relative illuminances and/or relative color values and/or relative light spectra provided by the comparator to determine the illuminance and/or color and/or spectral distribution with absolute illuminance, color, and/or spectral values.

The calibration device 11 can comprise one or more illuminance and/or color value sensors 12 for measuring the actual illuminance in one or more pixels and/or image areas, in which case the above-mentioned illuminance and/or color value sensor 12 can, for example, be mounted directly on the wall 3 or aimed at the wall 3 on which the wall image 4 is produced. If the actual illuminance in one or more pixels or image areas is known from sensor detection, then a calibration factor or illuminance correction factor can be determined, which can then be used to convert the relative illuminances into actual, absolute illuminance values.

For color and/or spectral calibration, however, the above-mentioned calibration device 11 can also have one or more RGB sensors or color value sensors in order to be able to measure actual color values in one or more pixels and/or image areas; such a color value sensor can, for example, be attached directly to the wall or aimed at the wall 3 on which the wall image 4 is produced. If the actual color value in one or more pixels or image areas is known from sensor detection, then a calibration factor can be determined, which can then be used to convert the relative color values, for example in the form of the RGB signals of the camera, into actual, absolute color values, for example in the form of “correct” color temperatures or color points.

Alternatively or in addition to such a color value sensor, however, the calibration device 11 can also use a hyperspectral camera with which a spectral measurement can be carried out pixel-by-pixel or line-by-line. Such a hyperspectral camera can, for example, be aimed at the wall 3 on which the wall image 4 is produced or can be aimed into the light cone emitted by the lighting fixture that is to be measured. The use of such a hyperspectral camera allows pixel-by-pixel spectral evaluations in different pixels and/or a view of the distribution.

Alternatively or additionally, the calibration device can also comprise an imaging illumination device 13 for illuminating the wall with a predetermined light-and-dark pattern, in particular a predetermined black-and-white pattern such as a checkerboard, see FIG. 5 (c), in which case the comparator of the illuminance and/or color and/or spectral distribution module 8 can, in a calibration procedure, determine the relative illuminance values for light and dark pixels and/or image areas of the above-mentioned predetermined light-and-dark pattern. Based on the knowledge of the black and white fields in the wall image of the calibration run, for example, it is then possible to determine a calibration factor or illuminance conversion factor that the illuminance and/or color and/or spectral distribution module 8 can then use to determine absolute illuminance values based on the relative illuminance values in the rectified camera image.

If the illuminance and/or color and/or spectral distribution has been determined for the rectified camera image, then based on this, a luminous intensity and/or color point and/or radiant intensity distribution module 9 can determine the luminous intensity distribution and/or the angle-dependent color point distribution and/or the spectral radiant intensity distribution of the lighting fixture 2, in which case the above-mentioned luminous intensity and/or color point and/or radiant intensity distribution module 9 can in particular take into account the position of the lighting fixture 2 relative to the wall 3 and/or the geometry of the wall surface section illuminated by the lighting fixture 2 and its geometric relationship to the lighting fixture 2.

The position and/or geometric relationship of the lighting fixture 2 relative to the wall 3 and/or wall image 4 can, for example, be entered manually via a suitable input interface 13 of the apparatus and/or be detected by an automatic position determination device and provided to the luminous intensity and/or color point and/or radiant intensity distribution module 11 via the above-mentioned input interface, for example in the form of a coordinate data set indicating the position of the lighting fixture 2 relative to the wall section that the camera 5 captures as a camera image.

The above-mentioned position data can in particular include the distance of the lighting fixture 2 from the wall 3 and/or a transverse offset of the lighting fixture 3 relative to the center or middle of the wall image being captured or of a predetermined wall image point such as two opposite corners. For example, the position data set can include the distance of the lighting fixture 2 perpendicular to the wall 3 and the vertical and horizontal offset of the lighting fixture 2 relative to the center of the wall image 4 produced by the lighting fixture 2 and captured by the camera 5.

The above-mentioned position data can be detected by sensors, for example by distance and/or position sensors 12.

As is clear from FIG. 5, in particular the left and middle depictions according to the partial views (a) and (b), a reference image of a reference lighting fixture can also be produced by a reference imaging device 20 and this reference image can, for example, be projected onto the wall 3 by the above-mentioned imaging illumination device 13. Such a reference image can, for example, include the intensity distribution and/or color distribution or the spectral distribution of the reference lighting fixture and show it in comparison to the corresponding color distribution or spectral distribution of the lighting fixture that is being analyzed. However, the overlay device and/or reference imaging device can also, for example, provide a false-color display of illuminance distributions of the lighting fixture that is being analyzed and/or of a reference lighting fixture. Similar to a topographical map, illuminances or intensities can be displayed in different “false” colors, in each case in order to visualize the above-mentioned quantities in an easily comprehensible way.

By comparing the lighting fixture that is being analyzed to a reference lighting fixture, for example by displaying light distributions, see FIGS. 5 (a), (b), the lighting characteristics and their differences from one or more reference lighting fixtures can be made visible and easily comprehensible.

Advantageously, it is possible to set up various comparisons that can be displayed by the reference image device 20, e.g. the real lighting fixture vs. simulation data, and/or the real lighting fixture vs. the real lighting fixture in a different state of development or in a different embodiment, and/or the real lighting fixture vs. a reference product, e.g. with lighting characteristics from an online catalog, and/or the real lighting fixture in false colors, and/or an overlay of the lighting fixture whose lighting characteristics are being determined.

Further comparisons can be selected from the depiction types.

What is claimed is:

1. An apparatus for determining the lighting characteristics of a lighting fixture having a camera for capturing a wall image produced on a wall by the lighting fixture and for providing a camera image based on the captured wall image and having an image evaluation device for evaluating the camera image, the image evaluation device comprising:
a distortion correction module for rectifying the camera image; a module for determining an illuminance, a color or a spectral distribution in the rectified camera image rectified by the distortion correction module; and
a distribution module for determining the luminous intensity distribution, the angle-dependent color coordinate distribution or the spectral radiant intensity distribution of the lighting fixture based on the illuminance, the color or the spectral distribution determined by the rectified camera image.

2. The apparatus according to claim 1, wherein the module further includes:
a comparator for comparing the at least one of the illuminance, the color value, and the spectral distribution in at least one of different pixels and image areas of the rectified camera image relative to each other, and
a calibration device for determining at least one of an absolute illuminance, an absolute color value, and an absolute spectral distribution from the previously determined at least one of relative illuminances, color values, and spectral distributions of the comparator.

3. The apparatus according to claim 2, wherein the calibration device comprises an illuminance and/or color value sensor for measuring the illuminance and/or color value in a pixel and/or image area.

4. The apparatus according to claim 2, wherein the calibration device comprises a hyperspectral camera with a sensor matrix for pixel-by-pixel detection of the color and/or spectral distribution.

5. The apparatus according to claim 2, wherein the calibration device comprises an imaging illumination device for illuminating the wall with a predetermined light-and-dark pattern, in particular a black-and-white pattern such as a checkerboard, and/or with a predetermined color pattern, wherein the comparator is embodied to determine, in a calibration procedure, the relative illuminance values for light and dark pixels and/or image areas of the light-and-dark pattern and/or the relative color values for different-colored pixels and/or image areas of the color pattern.

6. The apparatus according to claim 1, wherein the distortion correction module comprises an identification device for identifying key contours, which are straight contours and/or right angles in the wall image, in the camera image, and a calculation module for calculating and providing the rectified camera image based on a determined curvature deviation and/or angular deviation between the key contour that is identified in the camera image and the key contour that is present in the wall image.

7. The apparatus according to claim 6, wherein the distortion correction module comprises an imaging illumination device for illuminating the wall with a predetermined contour pattern, in particular a checkerboard pattern.

8. The apparatus according to claim 5, wherein the distortion correction module comprises a calculation module for calculating and providing a rectified light-and-dark and/or color pattern by means of the imaging illumination device based on a determined curvature deviation and/or angular deviation between the key contour that is identified in the camera image and the key contour that is present in the wall image.

9. The apparatus according to claim 8, wherein the distortion correction module comprises a calibrated camera for providing a calibrated camera image of the identified key contour.

10. The apparatus according to claim 1, wherein the distortion correction module comprises a stereo camera and/or two cameras spaced apart from each other and is embodied to calibrate the camera and the imaging illumination device based on the coordinates of the camera position and the coordinates of the position of the imaging illumination device on the basis of a comparison of the offset camera images.

11. The apparatus according to claim 1, wherein the image evaluation device comprises an area selection module for presetting an evaluation area of the wall image for the camera image that is to be evaluated.

12. The apparatus according to claim 1, wherein an image processing device is provided for assembling the camera image from two or more camera images that replicate parts of the wall image in two or more evaluation areas that differ from each other.

13. The apparatus according to claim 1, wherein the image evaluation device comprises an input interface for inputting the position of the lighting fixture relative to the wall and/or an automatic position determination device is provided for detecting the position of the lighting fixture relative to the wall, wherein the luminous intensity and/or color coordinate and/or radiant intensity distribution module is embodied to calculate the luminous intensity and/or angle-dependent color coordinate and/or spectral radiant intensity distribution of the lighting fixture on the basis of the input and/or automatically detected position of the lighting fixture relative to the wall and from the illuminance and/or color coordinate and/or spectral distribution, wherein the position determining device is embodied to determine the distance of the lighting fixture from the wall and the transverse offset of the lighting fixture from the center of the evaluation area of the wall image.

14. A method for determining the lighting characteristics of a lighting fixture, comprising:
capturing a wall image produced on a wall by the lighting fixture by a camera and providing a camera image based on the captured wall image, and
evaluating the camera image to determine the lighting characteristics of the lighting fixture, wherein:
a distortion correction module calculates a rectified camera image based on the camera image provided by the camera, then an illuminance and/or color and/or spectral distribution module calculates relative illuminance and/or color values and/or spectral distributions in different pixels and/or image areas of the rectified camera image relative to one another, and a calibration device provides an illuminance and/or color and/or spectral distribution based on the relative illuminance values and/or color values and/or spectral distributions, and a luminous intensity and/or color coordinate and/or radiant intensity distribution module determines the luminous intensity and/or angle-dependent color coordinate and/or spectral radiant intensity distribution of the lighting fixture based on the illuminance and/or color and/or spectral distribution on the basis of an input and/or automatically determined position of the lighting fixture relative to the wall.

15. An apparatus for visualizing the lighting characteristics of a lighting fixture, having a device for determining the lighting characteristics of the lighting fixture, which is embodied according to claim 1, and having an imaging illumination device for showing information in the wall image and/or next to the wall image on the wall, as a function of the previously determined lighting characteristics.

16. The apparatus according to claim 15, wherein the imaging illumination device comprises a projector.

17. An apparatus for visualizing the lighting characteristics of a lighting fixture, having a device for determining the lighting characteristics of the lighting fixture, which is embodied according to claim 1, and having a display device comprising a screen for displaying the camera image and/or the rectified camera image, wherein the display device comprises an overlay module for showing information on the screen as a function of the lighting characteristics previously determined from the camera image.

18. The apparatus according to claim 1, wherein pixel and/or image area selection means are provided for selecting a pixel and/or image area that is of interest in the camera image and/or in the rectified camera image, wherein the image evaluation device is adapted to determine the lighting characteristics for the selected pixel and/or image area, and wherein the imaging illumination device and/or the display module of the display device are embodied to display the lighting characteristics, which are determined for the selected pixel and/or image area, in the pixel and/or image area of the wall image and/or camera image displayed on the display device, which corresponds to the selected pixel and/or image area.

19. The apparatus according to claim 1, wherein a reference image device is provided for showing information about a reference lighting fixture in the wall image and/or next to the wall image on the wall and/or on the screen of the display device as a function of a lighting characteristic of the reference lighting fixture, wherein the reference imaging device (20) comprises a control module for controlling the imaging illumination device or the display device while taking into account the distortion effects of the camera and/or imaging illumination device that have been determined by the distortion correction module.

20. The apparatus according to claim 18, wherein the reference imaging device comprises a data interface for inputting the luminous intensity distribution and/or angle-dependent color coordinate distribution and/or spectral radiant intensity distribution of one or more reference lighting fixtures, wherein a/the control module is embodied to control the imaging illumination device and/or display device on the basis of the input luminous intensity distribution and/or angle-dependent color coordinate distribution and/or spectral radiant intensity distribution of the one or more reference lighting fixtures.
